(19) United States
(12) Patent Application Publication
(10) Pub. No.: US 2013/0122239 A1
(43) Pub. Date: May 16, 2013

(54) Perfect Heart: An article of manufacture and method of designing and interacting with a heart having utilitarian measurements

(71) Applicant: Tali Lehavi, Scottsdale, AZ (US)

(72) Inventor: Tali Lehavi, Scottsdale, AZ (US)

(21) Appl. No.: 13/672,805

(22) Filed: Nov. 9, 2012

Related U.S. Application Data
(60) Provisional application No. 61/558,285, filed on Nov. 10, 2011.

(51) Int. Cl. B44C 1/00; B44C 5/00

(52) U.S. Cl. CPC B44C 1/00; B44C 5/00
USPC 428/80; 29/592

(57) ABSTRACT

A design for a perfect geometric heart that has unique properties that make it more useful and practical is disclosed as well as a method for creating hearts for building mosaics and building block games, as well as a method for interacting with a set of such hearts. The top angle of the heart is designed to match the angle of the bottom of another or a similar heart. This way, a copy of the same heart can wedge to the bottom of the heart, and a first heart can wedge a second heart. In addition, an embodiment of such a heart is disclosed in which the top of the heart and the bottom have a matching 90 degree angle, can overlap top to bottom and sideways so that a plurality of hearts can perfectly stack or overlap in any of four different directions and maintain 90 degree angles in the spaces formed where the tops of where any two individual hearts meet, allowing for further wedging. Additionally, four hearts of the same unique embodiment can meet at the bottom tip and create eight more 90 degree angles so that even more hearts could wedge.

This application claims priority to and the benefits of provisional patent application Ser. No 61558285, filed Nov. 10, 2011, which is incorporated by reference in its entirety by the present inventor.

### FIELD OF THE INVENTION

The present invention relates to heart articles used for building games, mosaics, and jewelry mainly.

### PRIOR ART

No one has ever manufactured hearts for mosaics and building games in which the top has an angle that is designed to wedge to the bottom. In addition, no one has discovered that they can overlap a heart in the opposite direction of another heart to create a heart in every direction. In addition, no one has ever discovered that there is a special heart with unique proportions that can overlap another heart, having the same scale and shape, in the opposite direction in just the right place matching top to bottom to result in four hearts of the same exact dimensions as the first heart—in four different directions. Moreover, it is possible to create such a heart that can additionally form a third angle between itself and another heart of the same scale and shape, where this third angle matches the posterior angle of the original heart. This can allow a plurality of combinations in which a plurality of hearts of the same dimensions can always fit adjacent and wedge between each other. Finally, despite many building games on the market, no one has ever designed a heart that can be used in building games because none have had a useful, practical shape that can stack or fit neatly. Until now, no heart has had the proportions to allow it to connect or stack well with other hearts.

### BACKGROUND OF THE INVENTION

Hearts have been used in crafts for a long time. They have been a decorative design, usually appearing singly. Designs are never made solely from hearts, even though other geometric figures can repeat in many patterns. Unfortunately, people have never been able to use hearts like a tool because it has had a very uneven geometry. An official main heart design has never been proposed or defined. Hearts are introduced to young children as a geometric shape, but beyond that, it has not been studied and it has never been standardized. Mainly, the top of the heart has always had a curve that has not been made to match the angle of the bottom of the same or of another heart.

As a result, it has never looked appealing to place many hearts together in designs such as mosaics and other crafts and jewelry. In addition, no one has ever designed a building block game using hearts as blocks—for the same reasons described.

The present invention is about a very careful study that resulted in the discovery of a perfect heart. This perfect heart has such useful qualities that it becomes a tool for crafts, tiling, jewelry making, building block games, and other jobs. This perfect heart can be the standard used in a design, costing the manufacturer less because all the hearts will fit one another. Any heart designed with this invention in mind—paying attention that the top will match the bottom angle—will save in manufacturing and will allow for better, more aesthetic designs. Moreover, it will allow many hearts to wedge close together or almost near each other.

Finally, a unique standard heart proposed in one of various embodiments has such matching angles in so many locations that it will be even more useful than other hearts for the reasons that follow.

### SUMMARY OF THE INVENTION

In one of various embodiments, a perfect heart is proposed. It is perfect because it has a top and a bottom that both have matching ninety degree angles. In addition, when four of the same hearts meet at the bottom, creating an x-y axis in the space between them so that each heart is in a different quadrant, the angle that forms between the “shoulders” of each of these hearts is another ninety degree angle. This allows more hearts to wedge as they extend out. Designers who build mosaics can use this heart to create fascinating designs by endlessly wedging the heart pieces or by placing them adjacent but with a consistent space for aesthetics.

In addition, this perfect geometric heart can super impose on itself. When it does, it can continue to super impose further to create the same exact heart in four directions. This unique new image is fascinating. Only the heart with the dimensions disclosed in this invention can overlap perfectly in four different directions. Another embodiment morphs the heart shape so that it will overlap, create 90 degree angles, and have the added resemblance to the infinity symbol. This unique shape can be used in many games, allowing more hearts to wedge to it from four new ninety degree angles.

In another embodiment, the hearts can be manufactured so that bottom and top will meet, even if they are not the same exact heart.

### BRIEF DESCRIPTION OF DRAWINGS

FIG. 1 shows a heart and defines its parts.

FIG. 2 shows a heart with a ninety degree first angle and a ninety degree second angle.

FIG. 3 shows two hearts that wedge top to bottom.

FIG. 4 shows two hearts that overlay in inverse position and create as a result a heart in four different directions. No specific angle or length is specified.

FIG. 5 shows that when two hearts of 90 degree angles each at top and bottom inverse on each other and align top to bottom angles, they create four more ninety degree angles.

FIG. 6 shows four hearts placed adjacent to one another aligned along each leg and meeting at the first angle so that they are all around the same center point.

FIG. 7 shows two hearts adjacent and aligned, thereby creating a third angle.

FIG. 8 shows a third heart, of similar first and second angle, wedging at third angle created between two hearts of same first and second angles.

FIG. 9a shows a heart having a first angle that matches a second angle. 9b shows that the heart can wedge nicely with another heart. 9c shows that the heart can overlap on a similar heart and create a heart in four different directions, but that the two new hearts are not the same exact as the initial heart.

FIG. 10a shows a heart having curved legs that has the matching first and second angles, and additionally has predetermined lengths of legs and predetermined angles. This particular embodiment has 90 degree first and second angles. This particular embodiment will also create new ninety degree angles upon joining adjacent such as in FIG. 6. FIG. 10a is an official perfect heart, the feminine design, as defined by the inventor. The relationship of the lengths of the legs to the angles and curves must stay constant, although the heart can grow or shrink in scale—in this embodiment.

FIG. 10b shows the heart of 10a that allow it to overlap on itself.

FIG. 10c shows that the heart of 10a when overlapped, creates the same heart in every direction.

FIG. 11a shows a heart having straight legs that can overlap on a copy of itself and create the same exact heart in every direction as 11b shows.

FIG. 11c shows that the perfect heart of FIG. 11a can be used to overlap on itself and then create more 90 degree angles where more 90 degree first angles can wedge.

FIG. 12a shows a mosaic pattern created solely from the same sized heart. It is the masculine perfect heart.

FIG. 12b shows the mosaic pattern created using the feminine perfect heart.

FIG. 13a shows a pretty design using hearts of the same dimension in the same scale and wedged to a symbol created by the overlapping perfect hearts of 11a.

FIG. 13b shows a pretty construction for mosaics, crafts, and jewelry making that are possible with a single scale of a heart of a specific embodiment

FIGS. 14a and 14b show the masculine and feminine perfect hearts aligning along the legs in opposite directions.

### DETAILED DESCRIPTION OF VARIOUS EMBODIMENTS

The present invention is directed to a heart of predetermined angles and shapes designed for the purpose of interacting with additional hearts that also have predetermined angles and shapes. In particular, a heart with planned angles can wedge, stack, or overlap with other hearts.

Until now, no building toy or craft has produced a heart that is useful like a tool that can fit with other hearts. A process of manufacturing a heart that will have a first angle on top match a second angle at the posterior end is disclosed. A process of manufacturing a heart that will have a third angle that will match

A manufacturer often needs to build the tool or mold to produce an article of specific dimensions. When the dimensions change, the manufacturer needs a new tool or mold. So the more a single heart design can have multiple uses, the lower is the cost for manufacturing it.

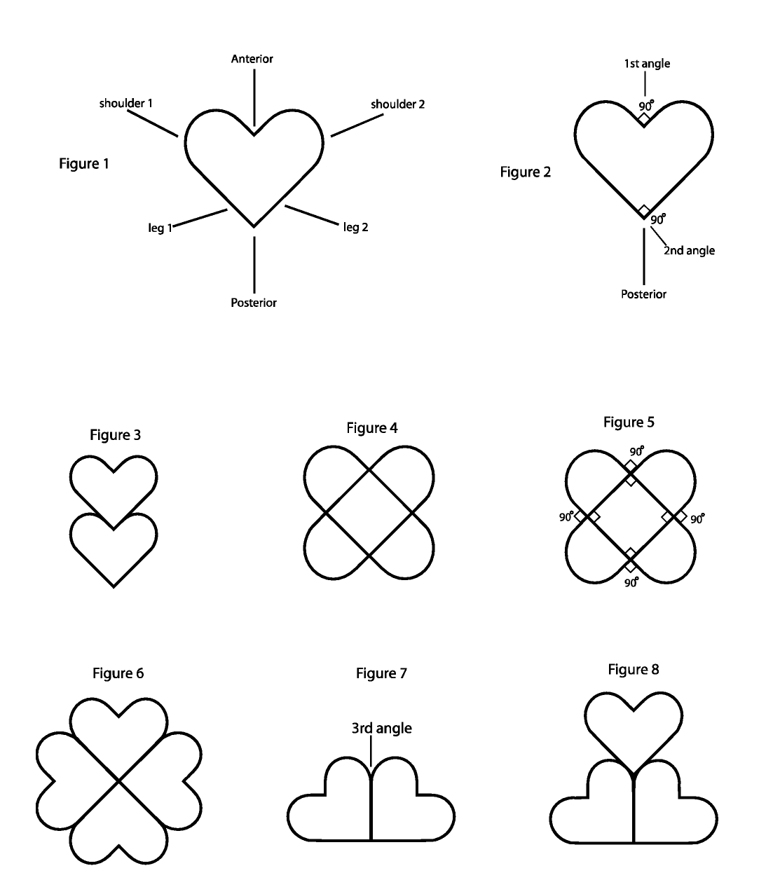

FIG. 1 assigns names to parts of a heart so that it will be easier to refer to each part. Until now, no one has really named parts of a heart. Only the parts needed to describe this invention are named.

FIG. 2 names the angles needed to refer to for this invention. FIG. 2 shows one of the various embodiments. It is a heart having a ninety degree first angle and a ninety degree second angle. The lines are relatively straight. It is possible in another embodiment to create a heart having ninety degree angles and at the same time some curves in the legs and curves in the top first angle to match. This is the heart later described in 10a.

It is also possible in another embodiment to have a top 1^{st} angle of a first heart match a bottom second angle of a second heart even though the second angle of a first heart may not match the first angle of a second heart. It is further possible to have a first and second angle both that match but are not ninety degrees. For example, it is possible to design a heart having a 60 degree first angle and a 60 degree second angle. The consideration of the size of the angle depends on the goal and budget of the manufacturer.

FIG. 3 shows two hearts that wedge together by fitting a first angle of a first heart with a second angle of a second angle of second heart. This is just the beginning of the possibilities in design, play action, and fun that can result from such a fit. It is also possible to scale a first heart in a different size from a second heart and still wedge them, because the angle stays the same. The inventor will invent a strategy game with tiles that wedge like this.

FIG. 4 shows the process of taking a first heart and a second heart and overlapping them to match a first angle of a first heart over the second angle of the second heart. The result is a heart in every direction!

FIG. 5 shows the result of a process described in FIG. 4 but using hearts of the unique proportions in this invention. The result is that more new ninety degree angles form. This will allow further fitting of additional hearts at each new angle.

FIG. 7 shows two hearts that align along leg 1 of one heart and leg 2 of another heart. Both meet at angle one. The angle that results is called angle three.

In FIG. 8, the third heart that wedges in the third angle is only able to do so because the hearts's first angle was planned in advance to match the angle that would form at the curve of the shoulders of the heart. This is possible to do all in one heart, so that the same heart in the same scale can be used to create FIG. 8. The heart's set of dimensions that achieves this is the heart presented in 10a and 11a. It is also possible to achieve using hearts with other angles. As long as the curve of a heart's shoulders is planned to match the curve of a first angle, this wedging will be possible.

FIG. 6 shows a heart that joins at the first angle with three other hearts as they align leg by leg all around without overlapping. Such hearts can be designed to have predetermined third angles to match their first angle, such as in FIG. 7. In this embodiment each of these hearts has a first angle, a second angle, and a third angle of 90 degrees. The result is that many more hearts can wedge and extend out, such as in FIG. 12a. The embodiment of a heart with the dimensions disclosed in 11a will be able to neatly arrange side by side in a circular fashion. This is highly appealing and practical. Infinitely more fascinating designs for mosaics are possible with the same exact sized and shaped heart.

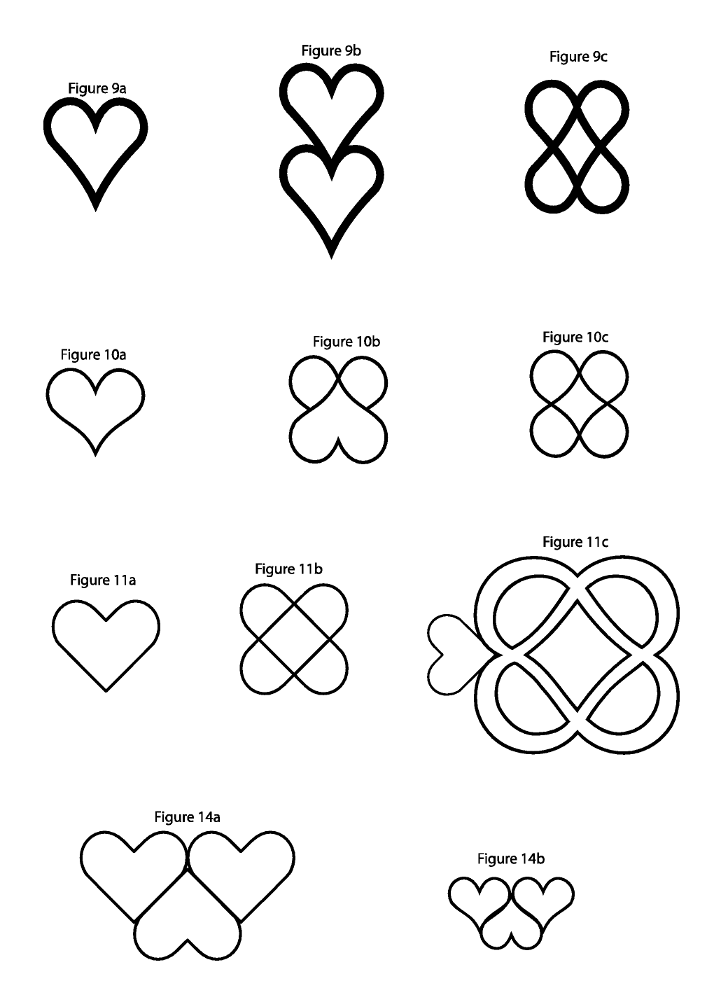

FIG. 9a shows a heart having a first angle that matches a second angle. The length of its legs are longer than the length disclosed for the perfect heart. The heart of 9a can still create a heart when it overlaps on itself in an opposite direction. However, as 9c shows, it won't create the same exact heart in every direction. FIG. 9b shows that the heart can wedge nicely with another heart.

9c shows that the heart can overlap on a similar heart and create a heart in four different directions, but that the two new hearts are not the same exact as the initial heart. That can look very artistic, even if it is not consistently the same heart all around. Any result of creating a heart in every direction is lovely and desirable. It can be used for jewelry and stacking toys for example. The method and process of taking a heart and overlapping it onto another heart is very desirable.

FIG. 10a shows a heart that has the matching first and second angles, and additionally has predetermined lengths of legs and predetermined angles that allow it to overlap on itself such as in FIG. 10b and additionally create the same heart in every direction such as in FIG. 10c. The first and second angles of this heart are 90 degrees, even though the lines that help create these angles are curved. The embodiment of the curves is attractive and the result of a heart in every direction is still possible. The embodiment of the curves gives this heart a feminine look. FIG. 10c shows that the heart of 10a when overlapped, creates the same heart in every direction.

FIG. 11a has the same properties as the heart in 10a except that the legs and matching second angle are straight. FIG. 11a will result in the same heart in the same scale in every direction when it overlaps on itself in opposite direction and aligns the first and second angles together. Both 11a and 10a will result in a third angle that can fit the first angle of the same heart. Thus, the heart of the invention in 10a and the heart of the invention of 11a have properties that no other heart has. The inventor calls both of these hearts a perfect heart. 11a is the masculine design, while 10a is the feminine design, as termed by the inventor.

Thus, in games where playing tiles are stacked, a player can stack a heart over another heart in one of four directions. Additionally, the angles that result are also 90 degrees, so more hearts can wedge all around as seen in FIGS. 11c and 13.

FIG. 11a shows a perfect heart in the sense that it can overlap on a copy of itself and create the same exact heart in every direction as 11b shows.

FIG. 11c shows that the perfect heart of FIG. 11a can be used to overlap on itself and then create more 90 degree angles where more 90 degree first angles can wedge.

FIG. 12a shows a mosaic created solely from repeating the same sized heart. The pattern can extend further out in this circular fashion. The unique dimensions of the heart are what allow it to repeat in such an aesthetic and mathematical fashion. It is because of the relationship of the length of the legs to the first angle.

The entire hearts and exact dimensions of heart 11a or 10a can be scaled smaller or larger and the special properties will remain constant.

In one of various embodiments, the heart of 11a is manufactured as flat wood playing pieces. The playing pieces can be used to create many patterns. The results of the patterns can be used for many purposes such as for tracing, for games, and for designing other surfaces. It may also be made of seeds, marble, foam, felt, plastic, glass metal, paper and many other materials. It may have a flat surface, a rough surface, or a round surface. It can have a cavity through it, or be used to make into boxes. It can have magnets in it or lights or other special effects. Many other variations are possible.

In various embodiments, the heart may have a first ninety degree angle and a second ninety degree angle but the length of the legs can vary. However, only when the specific heart of 11a or 10a with the specific proportions illustrated in this invention—taking into account the length of the legs and the shape and size of the curves of the shoulders, can the same exact heart overlap in every direction. The scale may vary and the result would stay the same.

In various embodiments, a smaller scaled heart of a ninety degree first and second angle can stack on top of a larger heart of the same dimensions. It can attach around the anterior point inside the heart. The angle around that point is 270 degrees. This means that three hearts could fit neatly within the big heart around that angle. Two hearts could also fit. One heart could fit in either direction—wedged at the first angle or aligned at the second angle.

FIG. 13a shows the symbol created by two hearts that overlap to create a heart in every direction as well as several hearts that fit into the first angles of the symbol and create a design coming out of it. All the hearts are of the same scale, although other designs are possible using hearts of matching angles, in other scales or other shapes.

FIG. 13b shows another design created by the heart of the embodiment described in 11a. The variety of possible designs is as varied as the designs are in nature.

The hearts need not wedge perfectly in for the designs to look appealing. As long as the angles look consistent then the distance between adjacent hearts will look aesthetic.

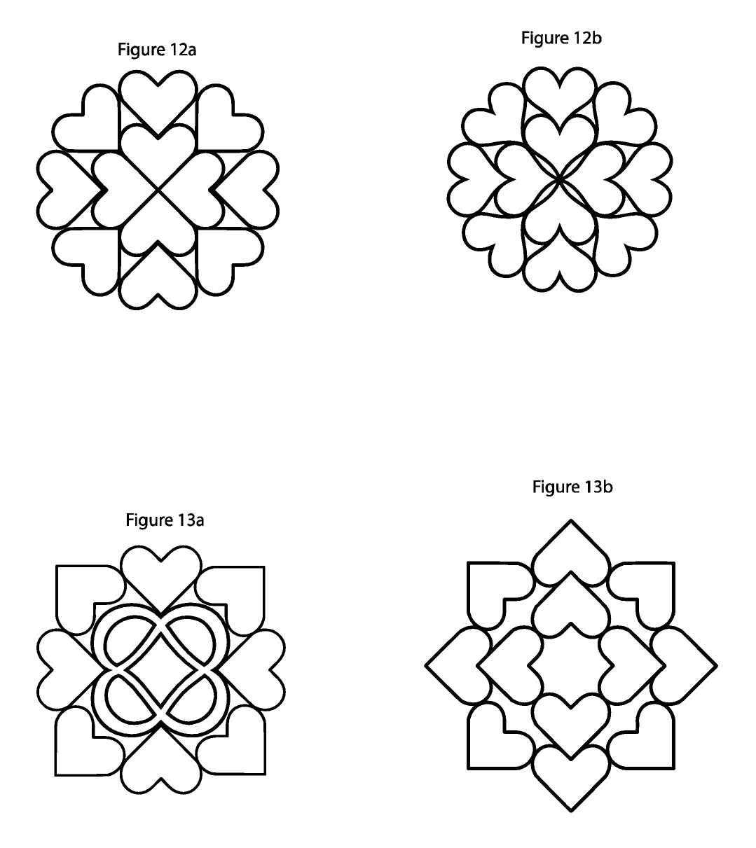

FIGS. 14a and 14b show that the perfect heart, in its masculine or its feminine form, is further useful for another embodiment out of many others. This basic construction can be used to produce much larger combinations. It shows the versatility of these unique perfect heart designs. The full potential of all the many beautiful arrangements is beyond the scope of the disclosure.

In various embodiments, the heart may wedge other hearts connecting its top to another heart's bottom such as for playing with building blocks. The heart may or may not have a positive and a negative space for hooking together, or other means of connecting. The heart need not stick to another heart. The heart can wedge with another heart which is enough. It produces an aesthetic effect, with enough challenge that is pleasing, and a satisfying sense of connectedness.

In other various embodiments, heart designs may stack over other heart designs, growing higher along the z axis. The hearts may recline horizontally layer, by layer. Or the hearts may have a means that allow them to stand up vertically and grow in 3D space, such as through releasable hook and loop materials or through having a male member extending from one heart and a corresponding female portion where it would be predetermined that the two should mate.

The philosophical aspect of hearts that connect is an added benefit to this invention. Hearts can represent people and nature. As we are all connected, so are the hearts. Even though many feel that we are symbolically hearts that connect, no one has manufactured heart articles that can wedge nicely until the designs of this inventor. No one has built mosaics that are purely made of heart pieces because the hearts have not been available.

In addition, no one has ever discovered that a heart can overlap on itself and thereby create a heart in every direction. When the exact heart disclosed in FIG. 11a is made as a building block, or a game piece, the heart of the exact proportions can perfectly overlap on itself in one of four different directions. The result is surprising and very effective. Symbolically, two hearts in opposite directions create love all around. A large variety of games can result from this new arrangement. In fact, the result is a whole new symbol and a whole new tool for expressing infinite goodness and love.

Finally, all the designs presented here are useful in software as well, for designing computer games, illustrations, and art. In addition, the items of manufacture can be used to create designs that are then used as stencils to create pieces of art. The hearts presented here would make great stencils and cookie cutters. Any process of making cookies in this shape and organizing them to fit angle to angle will allow the cookies to be presented in a more aesthetic arrangement. In addition, because the hearts can wedge neatly, an entire new alphabet and other images can be reproduced using such hearts. They truly become a tool for creating other images and products. A world of cartoon characters can be built as dolls and furniture all made of hearts that wedge like so.

While the invention has been particularly shown and described with reference to the embodiments thereof, it will be understood by those skilled in the art that the foregoing and other changes in form and details may be made therein without departing from the spirit and scope of the invention.

I claim:

1. A heart shape comprising, in combination: a posterior top and an anterior bottom predetermined to match in angle and shape

2. The heart shape of claim 1 wherein said posterior top is substantially similar to said anterior bottom so that when a two said heart shapes become adjacent, a top of a first said heart shape will have the ability to approximately fit to a bottom of a second said heart shape

3. The heart shape of claim 1 wherein said posterior top and said anterior bottom have an angle of ninety degrees in various embodiments

4. The heart shape of claim 1 where in various embodiments a first said heart shape can invert over a second said heart shape and align anterior of first said heart shape with posterior of second said heart shape,

5. The heart shape of claim 1 where in various embodiments a first said heart shape has a means to invert over a second said heart shape and align anterior of first said heart shape with posterior of second said heart shape providing a means of overlapping an additional said heart shape in any of four different directions

6. The heart shape of claim 1 where in various embodiments said heart has a means to meet adjacent to another said heart at said anterior bottom, without overlapping, where a third angle formed at point where said two hearts curve away from each other is of a predetermined curve to make possible further placement of an additional third heart

7. A process of manufacturing an article that is heart shaped, comprising in combination a top of a first heart shape and a bottom of a second heart shape, and providing a means for matching shape of said top to said bottom.

8. The process of claim 7 further providing a means to manufacture in various embodiments a ninety degree first angle for said anterior of heart and a ninety degree second angle for said posterior of heart

9. The process of claim 7 further comprising in various embodiments a means to manufacture a predetermined third angle that results by bringing adjacent two said hearts that align adjacent at anterior bottoms where shoulders of two hearts create said third angle

10. The process of claim 7 further providing a means in various embodiments to create said heart that can overlap on itself and stack consistently in a plurality of directions

11. The process of claim 7 further providing a means in various embodiments to create said heart having a posterior second angle that matches an anterior first angle and that can overlap on itself to create same said heart in every direction

12. A method of arranging hearts having a top portion of a first said heart match enough with a bottom portion of a second said heart and aligning said hearts

13. The method of claim 12 wherein said first heart can overlay a second said heart

14. The method of claim 12 wherein first said heart aligns with second said heart with a means to bring top of first said heart adjacent to bottom of a second said heart

15. The method of claim 12 where there is a means in various embodiments to take a first said heart and overlap it over a second said heart in a plurality of directions in which each additional heart stacks over a previous heart
